(19) United States
(12) Patent Application Publication
(10) Pub. No.: US 2025/0199616 A1
(43) Pub. Date: Jun. 19, 2025

(54) Gesture Recognition in Embedded Systems Using Neural Networks and Haptic Feedback Discrimination

(71) Applicant: Skywalk Inc., Palo Alto, CA (US)

(72) Inventors: Tyler Nai Ming Chen, Carlsbad, CA (US); Savannah Ashley Cofer, Lewis Center, OH (US); Junrui Yang, Hayward, CA (US)

(21) Appl. No.: 18/976,074

(22) Filed: Dec. 10, 2024

Related U.S. Application Data
(60) Provisional application No. 63/610,845, filed on Dec. 15, 2023.

(51) Int. Cl. G06F 3/01; G06F 3/03; G06N 3/0464

(52) U.S. Cl. CPC G06F 3/016; G06F 3/017; G06F 3/0304; G06N 3/0464

(57) ABSTRACT

A gesture recognition system includes a sensor mechanically coupled to a device, a haptic feedback component, and a processor configured to operate a trained statistical model. The statistical model processes sensor data to differentiate between user gestures and haptic feedback generated by the device itself. The system identifies gestures while excluding the haptic feedback interference, enabling accurate gesture detection even when haptic feedback is active. The statistical model is trained using both gesture data and haptic feedback data, including synthetic haptic events, to learn to discriminate between user-initiated motions and device-generated feedback. The system employs efficient processing techniques for embedded systems, including reuse of intermediate computations and adaptive sampling rates based on device state. Applications include wearable devices, phones, and augmented reality interfaces where gesture recognition must remain accurate despite active haptic feedback.

### CROSS-REFERENCE TO RELATED APPLICATIONS

This application claims the benefit and priority of U.S. Patent Application Ser. No. 63/610,845, filed on Dec. 15, 2023, which is hereby incorporated by reference herein in its entirety, including all references and appendices cited therein.

### FIELD

The present disclosure pertains to a gesture recognition system for embedded devices, utilizing a neural network for efficient and accurate processing of sensor data. It uniquely addresses the challenge of haptic feedback interference, ensuring precise gesture detection in various user scenarios.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions. One general aspect includes a device. The device also includes a sensor mechanically coupled to a device to detect a gesture; a haptic feedback component configured to generate haptic feedback in response to the detection of the gesture, and a gesture recognition system may include a processor configured to: receive sensor data may include motion information from the sensor, process the sensor data using a trained statistical model that has been trained using data may include both gesture motion data and haptic feedback motion data, identify a gesture using the trained statistical model by differentiating between first motion information corresponding to a user gesture and second motion information corresponding to haptic feedback generated by the haptic feedback component, and activate at least one response on the device based on the identified gesture. Other embodiments of this aspect include corresponding computer systems, apparatus, and computer programs recorded on one or more computer storage devices, each configured to perform the actions of the methods.

Implementations may include one or more of the following features. The device where the trained statistical model may include a convolutional neural network optimized for computational efficiency in embedded systems. The sensor may include: at least one inertial measurement unit (IMU); and at least one optical sensor, where the convolutional neural network processes combined input data from both the imu and the optical sensor. The convolutional neural network employs a WaveNet-style architecture configured to: store intermediate outputs from neural network layers in memory; and reuse the stored intermediate outputs in subsequent processing operations to enhance computational efficiency. The sensor operates at a first sampling rate for a first type of sensor data and at a second sampling rate for a second type of sensor data. Processing the sensor data may include operating on a moving window of the sensor data to maintain temporal relationships in the motion information. The trained statistical model is trained using synthetic haptic feedback events added to gesture training data to enable differentiation between user gestures and haptic feedback during operation. The operating state is determined by at least one of: a current application running on the device, a power level of the device, or a type of user interaction being detected. The sensor may include a plurality of channels sampled at different rates, and where the gesture recognition system buffers data from the plurality of channels to synchronize the sensor data before processing by the trained statistical model. Implementations of the described techniques may include hardware, a method or process, or computer software on a computer-accessible medium.

One general aspect includes a method for gesture recognition. The method also includes receiving sensor data, which may include motion information from a sensor mechanically coupled to a device. The method also includes processing the sensor data using a trained statistical model that has been trained using data may include both gesture motion data and haptic feedback motion data. The method also includes identifying a gesture using the trained statistical model by differentiating between first motion information corresponding to a user gesture and second motion information corresponding to haptic feedback generated by a haptic feedback component. The method also includes excluding the second motion information from gesture identification; and activating at least one response on the device based on the identified gesture. Other embodiments of this aspect include corresponding computer systems, apparatus, and computer programs recorded on one or more computer storage devices, each configured to perform the actions of the methods.

Implementations may include one or more of the following features. The method where the trained statistical model may include a convolutional neural network optimized for computational efficiency in embedded systems, where receiving the sensor data may include: receiving first sensor data from at least one inertial measurement unit (IMU); and receiving second sensor data from at least one optical sensor, where processing the sensor data may include processing combined input data from both the imu and the optical sensor using the convolutional neural network, and where processing the sensor data may include: storing intermediate outputs from neural network layers in memory; and reusing the stored intermediate outputs in subsequent processing operations to enhance computational efficiency. Receiving the sensor data may include operating the sensor at a first sampling rate for a first type of sensor data and at a second sampling rate for a second type of sensor data, and operating on a moving window of the sensor data to maintain temporal relationships in the motion information. The trained statistical model has been trained using synthetic haptic feedback events added to gesture training data to enable differentiation between user gestures and haptic feedback during operation. The operating state is determined by at least one of: a current application running on the device, a power level of the device, or a type of user interaction being detected. Receiving the sensor data may include: sampling a plurality of channels at different rates; and buffering data from the plurality of channels to synchronize the sensor data before processing by the trained statistical model. The trained statistical model may include a neural network implementing dilated causal convolutions for processing time-series sensor data. Training the neural network may include: generating synthetic haptic feedback events; incorporating the synthetic haptic feedback events into gesture training data; training the neural network to discriminate between gesture data and haptic feedback data; performing supervised learning using labeled training data that correlates sensor readings to specific gesture types; and optimizing the neural network for reduced power consumption in embedded system operation. Implementations of the described techniques may include hardware, a method or process, or computer software on a computer- accessible medium.

One general aspect includes a method for training a neural network for gesture recognition. The method also includes collecting first sensor data of user gestures from a device having a sensor mechanically coupled to the device. The method also includes collecting second sensor data of haptic feedback events generated by a haptic feedback component of the device. The method also includes generating a training dataset by: combining the first sensor data and the second sensor data; and labeling the combined sensor data to identify portions corresponding to user gestures and portions corresponding to haptic feedback events. The method also includes training a statistical model using the training dataset to: differentiate between motion information corresponding to user gestures and motion information corresponding to haptic feedback; and identify gestures while excluding the motion information corresponding to haptic feedback. The method also includes optimizing the statistical model for deployment on an embedded system. Other embodiments of this aspect include corresponding computer systems, apparatus, and computer programs recorded on one or more computer storage devices, each configured to perform the actions of the methods.

Implementations may include one or more of the following features. The method where training the statistical model may include: implementing dilated causal convolutions for processing time-series sensor data; and storing intermediate outputs from each layer to minimize repetitive computations, may include optimizing the statistical model may include: reducing model complexity to meet embedded system memory constraints; and configuring the model to operate on a moving window of sensor data. The method may include: generating synthetic haptic feedback events; and incorporating the synthetic haptic feedback events into the training dataset at random intervals. Implementations of the described techniques may include hardware, a method or process, or computer software on a computer-accessible medium.

### BRIEF DESCRIPTION OF THE DRAWINGS

FIG. 1 is a diagram illustrating the components of a gesture recognition system, including sensors, processor, memory, haptic feedback, and wireless communication.

FIG. 2 is a flowchart illustrating an on-device procedure during run-time operation for a gesture recognition system.

FIG. 3 is a flowchart illustrating an enhanced version of the on-device procedure during run-time with self-haptics detection.

FIG. 4 is a diagram illustrating a training data structure used to train the gesture recognition system, showing data collection under different haptic conditions.

FIG. 5 is a diagram illustrating a processing pipeline for handling haptic signatures in sensor data.

FIG. 6 is a flowchart illustrating a method for gesture recognition, including motion type analysis and haptic feedback processing.

FIG. 7 is a flowchart illustrating CNN and sensor data processing flow, showing the parallel processing of IMU and optical sensor data.

FIG. 8 is a diagram illustrating data sampling and buffering flow, showing the processing of different sensor types at different sampling rates.

FIG. 9 is a diagram illustrating the model training process, showing the incorporation of synthetic haptic events and gesture discrimination training.

FIG. 10 is a flowchart illustrating the state machine and parameter adjustment flow based on operating conditions and application requirements.

### DETAILED DESCRIPTION OF EXAMPLE EMBODIMENTS

### Overview

A system for gesture recognition includes neural network architectures configured for operation within embedded system environments. Examples of neural networks may employ dilated causal convolutions, allowing the processing of time-series data from various sensors with enhanced computational efficiency. These implementations can cover broad receptive fields while managing computational complexity, which can be beneficial for embedded systems with various processing capabilities.

The gesture recognition system can integrate data from an array of sensors, which may include inertial measurement units (IMUs) comprising accelerometers, gyroscopes, and magnetometers, and/or optical emitter and detector pairs. That is, some embodiments include only the use of IMUs in a device which incorporates a gesture recognition system disclosed herein.

Some integrations can facilitate the classification of gestures including finger taps and continuous motions. The neural network architecture can be configured such that output at a given moment may be based on preceding time steps, supporting temporal characteristics of the input data.

Implementations of the neural network can be configured for reduced latency and power consumption, which can benefit wearable devices where response time and battery efficiency are considerations. This can be implemented through approaches where intermediate outputs of the neural network may be preserved, reducing computational operations. Such approaches can address considerations between memory usage and computational demand within embedded systems.

In some implementations, the system includes methodologies for processing haptic feedback. As haptic feedback events generated by the device may affect sensor data and gesture recognition, the neural network can be trained to process these haptic feedback events. Training may include exposing the network to labeled data including synthetic or real-world haptic events, allowing processing of distinctions between gestures and device-generated feedback. Some implementations include preprocessing of data inputs to the neural network where interference associated with haptic feedback may be processed from the sensor data.

System operations can implement state-machine approaches, which can influence the activation and utilization of sensors and neural network processes based on user contexts. These approaches can support resource utilization and system efficiency in gesture recognition implementations.

### Example Embodiments

The present disclosure provides systems and methods for gesture recognition utilizing an embedded system optimized for computational efficiency while managing haptic feedback. The present disclosure provides for devices that are configured to accurately differentiate between user-initiated gestures and internally generated haptic feedback events. This distinction can help prevent the misinterpretation of haptic outputs as user inputs, which could lead to erroneous device responses.

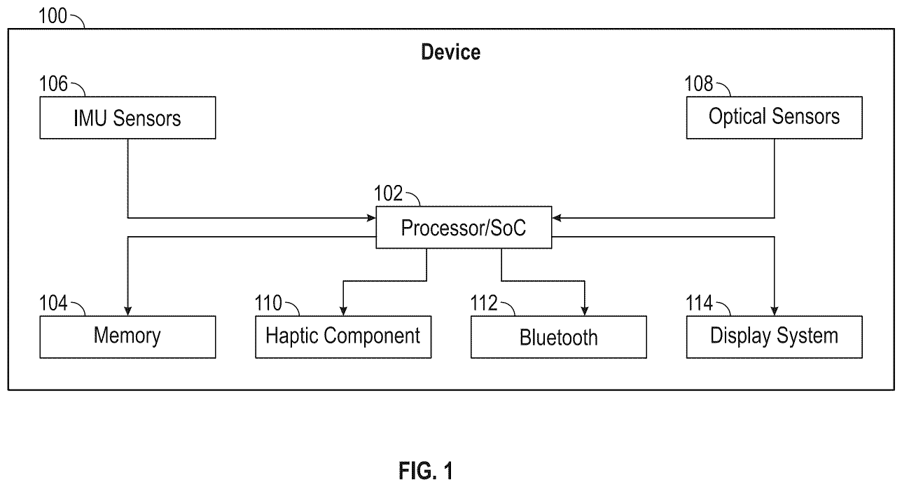

FIG. 1 illustrates device 100, which includes a processor/SoC (System on a Chip) 102 connected to various components critical for gesture recognition. The device integrates Inertial Measurement Unit (IMU) sensors 106, such as accelerometers, gyroscopes, and magnetometers, for capturing high-frequency motion data, and optical sensors 108, such as photodiodes and emitters, for spatial and depth information. These sensors collectively provide motion and spatial data, respectively, which are processed by processor 102 using a trained statistical model. The statistical model is optimized for real-time analysis and differentiates between user-initiated gestures and haptic feedback. While the device 100 is shown as having both IMU and optical sensors, the device 100 can include IMU sensors alone or optical sensors alone.

The IMU sensors 106 are mechanically coupled to the device, ensuring precise motion detection influenced by the device's structural characteristics. Similarly, optical sensors 108 enhance the system's ability to recognize gestures involving subtle spatial movements. Although IMU and optical sensors are primary examples, the system is designed to be flexible and compatible with other types of sensors, such as ultrasonic sensors, capacitive touch arrays, or even thermal imaging sensors, depending on application requirements.

Memory 104 stores operational data and statistical models, while the haptic feedback component 110 generates tactile feedback in response to detected gestures. Bluetooth 112 facilitates wireless communication, and display system 114 provides visual outputs for user interaction.

As used throughout this disclosure, the term “statistical model” refers broadly to any mathematical or computational model capable of processing sensor data to identify gestures and differentiate between user-initiated gestures and haptic feedback. Statistical models encompass, but are not limited to, neural networks (including convolutional neural networks, recurrent neural networks, and other architectures), support vector machines, hidden Markov models, decision trees, random forests, and other machine learning or algorithmic approaches for pattern recognition and classification. While the described embodiments detail implementations using convolutional neural networks with specific architectures such as WaveNet-style configurations, one skilled in the art will recognize that other types of statistical models could be employed while remaining within the scope of the claims, provided they are trained on appropriate gesture and haptic feedback data and optimized for embedded system deployment. The choice of specific statistical model implementation may depend on factors such as the computational resources available, power constraints, required response latency, and the complexity of gestures to be recognized.

A WaveNet-style architecture referenced herein implements dilated causal convolutions in a specific manner optimized for processing temporal sensor data. This architecture employs a stack of dilated convolution layers where each layer's dilation rate increases exponentially, typically by powers of 2 (1, 2, 4, 8, etc.). This expanding receptive field allows the network to efficiently process long sequences of sensor data while maintaining temporal causality-meaning predictions at each timestep depend only on current and previous inputs, not future ones. The architecture includes residual and skip connections between layers to facilitate gradient flow during training and improve model convergence. For embedded system optimization, the network employs depth-wise separable convolutions to reduce computational complexity while maintaining model capacity. The WaveNet-style implementation specifically adapts these architectural elements for the gesture recognition domain, with modifications to handle multi-modal sensor inputs (IMU and optical) and to efficiently process haptic feedback signatures.

In some embodiments, gesture recognition performed by the processor 102 is designed to account for device-specific characteristics, including the mechanical housing's resonant frequency and response properties. The IMU sensor(s) 106 is mechanically coupled to the device's structure, which influences the vibration patterns detected during gestures. Unique physical properties are used to tailor the machine-learning model to the specific device configuration. For example, the model trained for a wrist-worn device differs from that used in a phone, as the vibration and motion signatures vary significantly between these form factors.

In more detail, resonant frequencies inherent to the device structure are systematically characterized and used to enhance gesture recognition accuracy. The device housing, sensors, and internal components form a coupled mechanical system with distinct natural frequencies and mode shapes. These resonant modes can be excited during gesture execution, creating characteristic frequency signatures that aid in gesture classification.

The device-specific resonant frequencies are determined through mechanical characterization testing. In some embodiments, this characterization involves applying controlled impact excitation to the device while measuring the vibrational response using IMU sensor(s) 106. Fast Fourier Transform (FFT) analysis of the sensor data reveals the natural frequencies and corresponding mode shapes of the device structure. Additional frequency response data is captured by performing swept-sine vibration testing across the frequency range of interest.

The identified resonant frequencies serve as feature extractors in the gesture recognition pipeline. When a user performs a gesture, the motion naturally excites specific structural modes based on the gesture's force profile and contact location. The amplitude and decay characteristics of these resonant responses provide additional discriminating features for the machine learning model. For example, a tap gesture may predominantly excite high-frequency modes, while a swipe gesture may trigger lower-frequency structural responses.

The mechanical coupling between IMU sensor(s) 106 and the device structure creates frequency-dependent transfer functions that modify the measured sensor signals. These transfer functions are influenced by factors including sensor mounting location, structural damping properties, and the spatial distribution of device mass. The gesture recognition model incorporates these device-specific frequency response characteristics to optimize classification accuracy for the particular hardware configuration.

In some embodiments, the resonant frequencies are continuously monitored during device operation to detect potential changes in structural dynamics that could impact gesture recognition performance. Environmental factors such as temperature variation and mechanical wear may cause slight shifts in the natural frequencies over time. The model adapts to these changes by updating its frequency-dependent feature extraction parameters based on the current resonant characteristics of the device.

The definition of a “gesture recognition system” as used herein includes a combination of hardware and software components integrated within device 100 to enable gesture detection and interpretation and includes at least the processor 102. On-device sensors provide raw data that is processed by processor 102, which operates a trained statistical model, such as a convolutional neural network (CNN). Memory 104 stores the trained model and any intermediate data required for efficient processing. The gesture recognition system can also incorporate a haptic feedback component 110, which generates tactile outputs in response to detected gestures, enhancing user interaction. Software components coordinate data collection, synchronization across sensors, and the execution of gesture recognition algorithms. Wireless communication via Bluetooth 112 and visual outputs through display system 114 enable further interaction with external systems.

The device 100 can be implemented as a virtual reality headset that includes a processor, memory, and sensors for gesture recognition, along with a display for presenting virtual content. While described with reference to a virtual reality headset, the architecture can also be applied to other devices such as wrist-worn devices, mobile phones, or augmented reality glasses, maintaining its ability to differentiate between user gestures and device-generated haptic feedback.

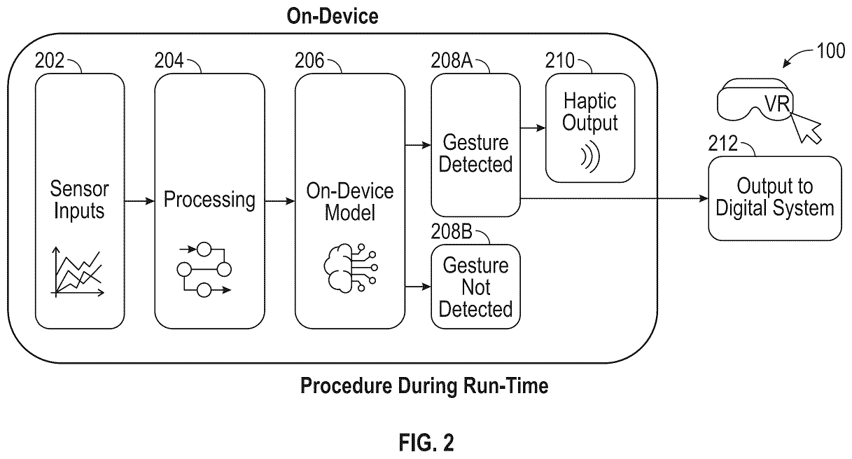

FIGS. 1 and 2 collectively illustrate a gesture recognition process executed on device 100, where sensor inputs 202 include data from both IMU sensors 106 and optical sensors 108. The IMU sensors 106 operate at a higher sampling rate with fewer channels, while the optical sensors 108 function at a lower frequency with a larger number of channels. In one embodiment, the IMU sensors 106 sample at 833 Hz, and the optical sensors 108 generate a full cycle of data from 88 channels every 18 IMU samples, approximately 46 Hz. This results in one sample×88 channels of optical data and 18 samples×3 channels of IMU data being added to the buffer at each timestep.

In one example, the IMU sensors 106 operate at a high sampling rate of 833 Hz to capture rapid hand movements and subtle gesture nuances, providing 3-channel data (x, y, z acceleration) at microsecond-scale temporal resolution. This sampling rate was selected based on empirical analysis of human gesture speeds and the mechanical response characteristics of the device housing. The optical sensors 108 operate at 46 Hz, generating readings across 88 channels that capture spatial positioning data. This lower sampling rate for optical data reflects both power optimization requirements and the relatively slower rate of change in spatial positioning during gesture execution. The ratio between these sampling rates (approximately 18:1) allows efficient buffering and synchronization while maintaining complete gesture capture. These specific sampling rates may be adjusted based on the device type, use case, and power constraints, but maintain the general relationship where IMU sampling occurs at a significantly higher frequency than optical sampling.

In some instances, the processor 102 employs a moving window mechanism to analyze sensor data over time while preserving temporal relationships crucial for accurate gesture detection. For example, each window may span 100 ms of sensor data and advances in 10 ms increments, ensuring that the processor 102 captures overlapping segments of motion for comprehensive analysis. Within each window, sensor readings from multiple sensors, such as the IMU and optical sensors, can be aligned and synchronized despite differing sampling rates. For instance, IMU data sampled at 833 Hz and optical sensor data sampled at 46 Hz are buffered and interpolated to produce a unified data stream.

The processor 102 evaluates data within the moving window through a convolutional neural network (CNN) employing dilated causal convolutions, which extend the receptive field without increasing computational complexity. By focusing on time-series patterns within each window, the CNN identifies gestures while accounting for temporal dependencies. Intermediate outputs from earlier layers of the CNN are cached and reused in subsequent processing cycles to reduce redundant computations, optimizing the system for low-latency embedded environments. These examples are not intended to be limiting but are provided for explanatory purposes.

The buffered sensor data is processed in a processing stage 204, which includes a data buffering mechanism optimized for handling the differing sampling rates and channel capacities of the IMU sensors 106 and optical sensors 108. This ensures the synchronized and formatted data is appropriately prepared for input into the on-device model 206 for effective gesture recognition. The processing stage 204 is designed for energy efficiency and real-time responsiveness, enabling quick responses to gestures while minimizing power consumption.

For example, the system can activate one or more device responses based on the detected gesture and current device state. Primary response categories include haptic feedback patterns, digital control signals, and system state transitions. For haptic responses, the haptic feedback component 110 generates precisely timed tactile outputs with characteristic waveforms matched to specific recognized gestures. For example, a detected tap gesture may trigger a short-duration (e.g., 50 ms) haptic pulse with specific amplitude and frequency characteristics, while a continuous gesture like a swipe may generate a progressive haptic pattern that tracks the gesture motion.

Digital control responses encompass both internal state changes and external communications. Internal responses include activating specific device functions, modifying operational parameters, or triggering state machine transitions. External responses typically involve transmitting gesture classification results through Bluetooth 112 to connected systems like VR headsets, with transmission timing optimized to balance latency and power consumption.

The activation framework could implement a priority-based response queue to manage multiple simultaneous responses while maintaining system stability. This queuing system ensures proper temporal sequencing when multiple gestures are detected in rapid succession or when haptic feedback events overlap with new gesture detections. The framework also monitors system resources, adjusting response characteristics based on available power and processing capacity to maintain reliable operation across varying device states.

The on-device model 206 utilizes a convolutional neural network (CNN) engineered for efficient operation in embedded systems. The CNN employs a WaveNet-style design with dilated causal convolutions, enabling the processing of diverse input data while preserving temporal sequence integrity. Its architecture incorporates depth-wise separable convolutions to reduce computational demands, and advanced algorithms ensure the device's CPU recognizes and accounts for haptic feedback during gesture recognition, maintaining high accuracy for user interactions.

Power optimization in the gesture recognition system employs multiple techniques operating at different levels. At the sensor level, dynamic sampling rate adjustment responds to user activity and device state, reducing power consumption during periods of inactivity. The CNN implementation utilizes quantized weights and activations, reducing both memory requirements and computation power. The WaveNet-style architecture's efficient handling of temporal dependencies minimizes redundant calculations through its cached intermediate outputs. Power optimization extends to memory management, where the system selectively stores only essential intermediate outputs needed for subsequent processing steps. The state machine implements power-aware transitions between operating modes, adjusting the active sensor set and processing pipeline based on application requirements and battery level. For example, in low-power mode, the system may disable optical sensors and rely solely on IMU data, trading some accuracy for extended battery life. The neural network can be quantized to 8-bit precision during deployment, reducing both memory bandwidth and computation power while maintaining acceptable accuracy levels. These optimization techniques are particularly important for wearable devices where battery life is a critical constraint.

The on-device model 206 can store intermediate outputs after the first forward pass, conserving memory and computational resources. In some embodiments, not all layer outputs are stored-only those used for computing intermediate results for future timesteps—creating an optimized trade-off between memory usage and computational demand.

While the architecture of the on-device model is optimized for efficient processing, its effectiveness ultimately depends on the quality and comprehensiveness of its training data. The model must learn to recognize not only the variety of possible user gestures but also distinguish them from device-generated haptic feedback and environmental noise. This requires carefully structured training data that captures both the intended gestures and potential interference patterns. The training process involves exposing the model to diverse scenarios and explicitly labeling different types of motion signals, enabling it to develop robust discrimination capabilities.

The processor 102 can determine whether a gesture is detected (208A) or not detected (208B). The on-device model 206 incorporates algorithms that differentiate between user-initiated gestures and haptic feedback generated by the device 100, ensuring accurate interpretation of user inputs without interference from device-generated feedback.

When a gesture is detected, the gesture recognition system generates a haptic output 210 through a haptic feedback component and simultaneously transmits an output 212 to a connected digital system. Haptic feedback provides tactile responses to specific gestures, such as a buzz when a click is recognized, enhancing user engagement. The output 212 may be transmitted via Bluetooth 112 to external devices, such as virtual or augmented reality headsets, ensuring seamless and immersive user experiences. For example, gesture predictions can be transmitted at a lower frequency of 15 Hz to reduce wireless data transmission while the device 100 collects and processes sensor data at higher rates.

In some embodiments, the process operates under state machine logic, which manages sensor control and processing outputs based on the current operating scenario. This logic dynamically determines sensor activity and neural network processing requirements according to user context. For example, high-frequency optical sensing may be used for detailed hand-tracking in an immersive game, while low-power scenarios can adjust sensor sampling rates and processing parameters to conserve energy, albeit with increased latency.

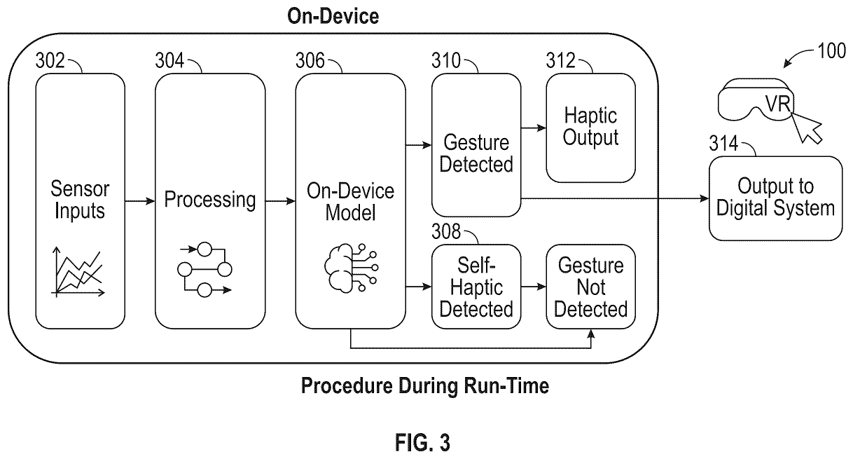

FIGS. 1 and 3 collectively illustrate an enhanced version of the on-device procedure during run-time that accounts for self-haptics detection. The process begins with sensor inputs 302, which include data from IMU sensors 106 and optical sensors 108, feeding into a processing stage 304. The processing stage 304 synchronizes and formats the data for input into the on-device model 306. The on-device model 306 processes the sensor data to identify potential gesture events with self-haptics detection 308 operating in parallel to identify haptic feedback events generated by the device itself. This parallel processing architecture enables simultaneous detection of both user gestures and device-generated haptic feedback.

The self-haptics detection 308 can operate independently from the gesture detection path at step 310, allowing the system to maintain gesture recognition capability even during active haptic feedback events. When a gesture is detected at step 310, the processor 102 generates both a haptic output 312 through the haptic feedback component 110 and an output 314 to a connected digital system such as a click or tap activation. The processing stage 304 employs advanced algorithms that allow the processor 102 to maintain gesture recognition. By incorporating examples of haptic feedback events into the training dataset, the gesture recognition system trains the machine learning model to identify haptic feedback signatures while maintaining gesture detection capability. For instance, the model can process a deliberate user gesture that occurs simultaneously with a system-generated haptic feedback event, such as a hover-triggered vibration. This capability ensures reliable gesture detection across all device operating states, including scenarios where haptic feedback is actively used to enhance user interaction.

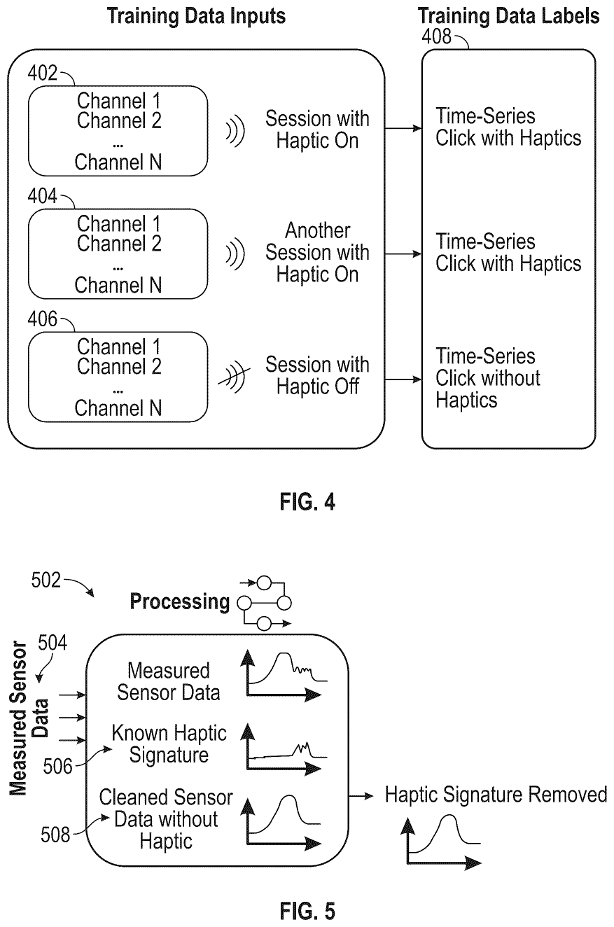

FIG. 4 illustrates a simplified training data structure used to train the gesture recognition system. The training data includes multiple channels of sensor data collected under varying conditions. A first set 402 represents data from sensor Channel 1 through Channel N during a session with haptics enabled. A second set 404 includes data from another session with haptics enabled, while a third set 406 contains data from a session with haptics disabled.

The training data further includes explicitly labeled time-series data 408 for clicks with haptics enabled and clicks without haptics. These synthetic datasets allow the model to be trained with controlled data that mimic real-world scenarios, including occurrences of haptic events. By exposing the model to both gesture data and haptic feedback data, the model learns to differentiate between them effectively. This labeling strategy supports the supervised learning approach used in training the neural network, associating each input with specific labels that indicate whether a gesture occurred and whether haptic feedback was present.

It will be understood that a synthetic haptic feedback event refers to artificially created data that replicate the motion signals generated by a device's haptic feedback component, such as vibrations or pulses. These events are designed to mimic the physical characteristics of real haptic feedback, including parameters like amplitude, frequency, and duration. Synthetic events may be created using computational simulations, recordings of actual device feedback under controlled conditions, or modifications of recorded data to reflect a broader range of scenarios.

One purpose of generating synthetic haptic feedback events is to augment training datasets for machine learning models used in gesture recognition systems. By including these events in the training data, the system can learn to distinguish between motion patterns caused by user-initiated gestures and those resulting from the device's own haptic feedback. This distinction is critical in scenarios where haptic feedback is frequently used, as it prevents false positives and improves the system's accuracy.

Synthetic events also allow the training process to cover edge cases and scenarios that may not be frequently encountered in real-world use. By exposing the model to a wide range of synthetic feedback patterns, developers ensure robustness against unexpected or uncommon haptic interference.

An example gesture recognition system employs a machine learning model trained to distinguish between user gestures and device-generated haptic feedback. The training dataset includes examples of gestures performed by a plurality of individuals, capturing a wide range of motion patterns to enhance the model's robustness. Additionally, non-gesture events, such as incidental taps or vibrations caused by haptic feedback, are explicitly included in the dataset. The model learns to identify these events as “not gestures,” leveraging a combination of statistical analysis and machine learning techniques to reject such inputs during operation. For instance, hardcoded thresholds are applied to acceleration data, rejecting motions that exceed physically plausible values for gestures.

FIG. 5 illustrates an embodiment of the processing pipeline 502 for handling haptic signatures in the sensor data within the gesture recognition system. This gesture recognition system, comprising components such as the processor, IMU sensors, optical sensors, haptic feedback mechanisms, and the trained statistical model, processes measured sensor data 504, which may include both gesture information and haptic feedback signatures. A known haptic signature 506 is maintained by the gesture recognition system and used by the trained statistical model to differentiate between genuine user gestures and motion caused by haptic feedback. The model processes the measured sensor data while accounting for the known haptic signature, ensuring accurate gesture detection even when haptic feedback is present.

The gesture recognition system may employ a trained statistical model that learns to recognize motion patterns associated with both gestures and non-gesture inputs. This approach enables the gesture recognition system to manage haptic feedback, incidental device movement, and other spurious signals, producing clean sensor data without haptics 508. The statistical model is trained with diverse data categories, including synthetic haptic feedback events, environmental vibrations, and incidental contact.

In some embodiments, synthetic haptic feedback events comprise two example, distinct categories of haptic signatures that the system can process during gesture recognition. The first category includes purely computer-generated haptic outputs produced by the haptic feedback component 110 according to predetermined patterns or in response to specific device states or user interactions. The second category encompasses augmented haptic events, wherein device-generated haptic feedback combines with concurrent sensor data from device motion, environmental vibration, or other mechanical disturbances to create composite vibrational signatures. The system processes both categories of synthetic haptic feedback to maintain accurate gesture detection during active haptic feedback operation.

The training process specifically addresses both categories of synthetic haptic feedback events to ensure robust gesture recognition. For purely computer-generated events, the system captures and catalogs the characteristic vibration patterns produced by haptic feedback component 110 under controlled conditions. These patterns serve as baseline signatures for training the statistical model to identify and account for device-generated feedback. For augmented haptic events, the training process combines recorded haptic feedback with real- world motion data, creating complex composite signatures that represent scenarios where device feedback occurs simultaneously with user movement or environmental disturbances.

The gesture recognition system applies a hybrid approach to motion filtering, combining hard-coded thresholds with machine learning-based classification. Hard-coded thresholds eliminate motions that exceed the physical possibilities of valid gestures, such as acceleration values beyond 10 G for wrist-worn devices. These thresholds are device-specific, adapting to the mechanical and functional characteristics of different form factors. For instance, head-mounted devices employ stricter thresholds due to constrained head movements, while handheld devices tolerate higher motion thresholds for broader arm movement detection.

Beyond initial filtering, the statistical model employs learned pattern recognition to classify incoming sensor data. Device-specific training further refines the model, accounting for variations in mechanical response caused by factors such as housing materials and internal component arrangements. For example, phone back-tap detection requires training with data that captures resonant frequencies specific to each phone model and configuration, potentially including data from other sensor types as described earlier. Similarly, wrist-worn devices incorporate training data reflecting vibrations from both user gestures and the device housing.

The processing pipeline 502 includes multilayer motion discrimination, ensuring precise gesture detection even in complex scenarios. Examples of rejection categories in the training data include incidental motions (e.g., sleeve brushing against the device), environmental vibrations (e.g., running or walking), and device-specific noise patterns.

By treating gesture recognition as a pattern recognition task rather than purely a signal separation problem, the system achieves high reliability and adaptability. The integration of state machine logic allows the system to dynamically adjust its operation based on application requirements, user interaction patterns, and device conditions. For example, the system transitions to high-precision sensing for 3D spatial gestures in immersive applications and reduces sensing rates to conserve power during simple 2D interfaces.

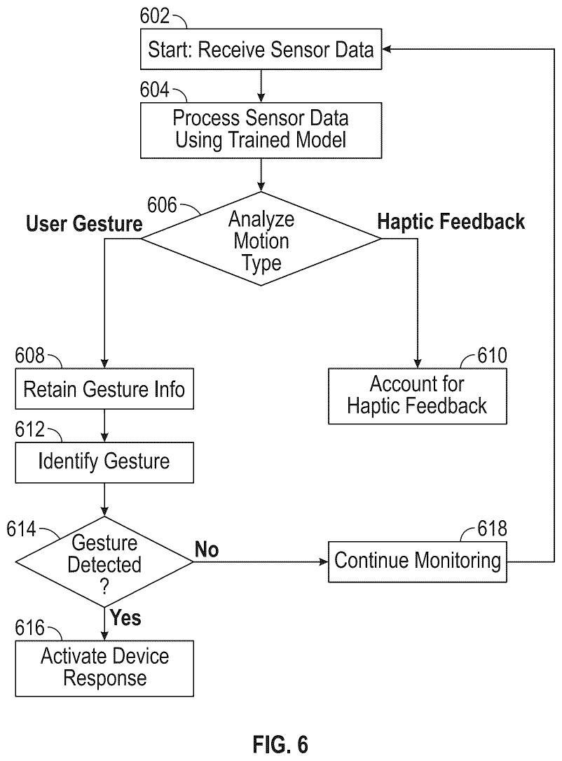

FIG. 6 illustrates a method for gesture recognition. The method begins with receiving sensor data 602, which includes motion information captured from a sensor mechanically coupled to a device. This data originates from one or more sensors, such as an inertial measurement unit (IMU), configured to detect motion. The system processes the received data using a trained statistical model 604, which has been trained with datasets incorporating both gesture motion and haptic feedback data.

The method continues with analyzing the motion type 606 to classify it as either a user gesture or motion caused by haptic feedback. This classification step ensures the system focuses on meaningful user interactions while disregarding internal feedback interference. When user gesture motion is identified, the corresponding data is retained for further analysis 608, enabling accurate tracking and processing of the gesture's characteristics. In cases where haptic feedback motion is identified, it is accounted for and processed 610 to prevent interference in the gesture recognition pipeline.

Subsequently, the system identifies gestures 612 using the refined and classified data. At decision point 614, the system evaluates whether a recognized motion constitutes a valid gesture. If a gesture is detected, the system proceeds to activate a corresponding device response 616, such as triggering a haptic output or executing a command. If no gesture is detected, the system continues monitoring 618 and returns to receiving sensor data 602, maintaining a continuous and adaptive recognition cycle.

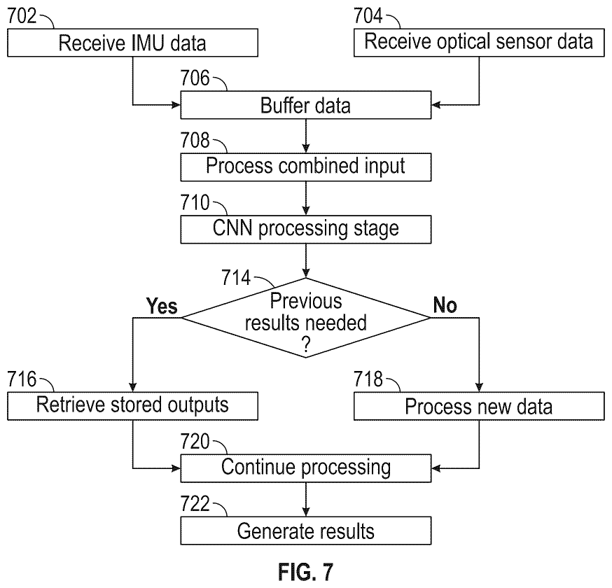

FIG. 7 illustrates an embodiment of the CNN and sensor data processing flow, implementing an efficient architecture for temporal gesture recognition. The system employs dual input channels: IMU sensors providing high-frequency motion data 702 and optical sensors collecting complementary spatial information 704. These independent data streams initially converge at a buffering stage 706, where temporal alignment of the disparate sampling rates occurs.

Following data buffering, the system implements decision point 708 that evaluates whether previously stored computational results should be incorporated into the current processing cycle. This early-stage decision enables optimal utilization of temporal context in the subsequent neural network analysis. Based on this evaluation, the system either retrieves stored outputs from memory 710 or processes the new sensor data independently 712.

Both processing paths feed into a combined input processing stage 714, where the system integrates current sensor data with any retrieved historical context into a unified format optimized for neural network analysis. This strategically preprocessed data then enters the CNN processing stage 716, where the neural network can leverage both current and historical information for enhanced gesture recognition accuracy.

The CNN processing stage 716 implements an architecture specifically optimized for embedded system deployment, utilizing the temporal context established in previous stages to improve recognition accuracy. The processed data advances through a continuation stage 718 where definitive gesture recognition results 720 are generated.

In another example embodiment, a system can implement a streamlined data processing pipeline optimized for high-frequency inertial measurement data. This architecture focuses on efficient processing of temporal motion patterns captured through accelerometer and gyroscope sensors mechanically coupled to the device housing.

The system acquires multi-axis acceleration and rotational velocity data from the IMU sensor array at precisely controlled sampling intervals. This high-temporal-resolution data captures both rapid gestural movements and subtle motion signatures, including device- generated haptic feedback patterns.

A dedicated buffer management system implements an overlapping window approach for the IMU data stream. This mechanism maintains temporal continuity by advancing in precise increments while preserving sufficient historical context for gesture recognition. The buffer depth is specifically optimized for the characteristic temporal spans of target gestures while minimizing memory overhead.

The convolutional neural network employs a temporal processing structure optimized for single-stream IMU data analysis. The network architecture strategically caches intermediate computation results at key processing nodes, enabling efficient reuse of relevant temporal features without redundant calculations. This cached-output approach is particularly critical for embedded implementations where computational efficiency directly impacts power consumption.

A discrimination layer within the network architecture enables concurrent analysis of both user-initiated gestures and device-generated haptic feedback patterns. Rather than attempting to remove haptic signatures from the input stream, the system learns to identify and process both signal types simultaneously, allowing accurate gesture recognition even during active haptic feedback events.

The system produces gesture classification results while maintaining awareness of concurrent haptic activity, enabling appropriate device responses without false triggering from feedback-induced motion. This approach preserves system responsiveness while ensuring reliable gesture detection during dynamic device operation.

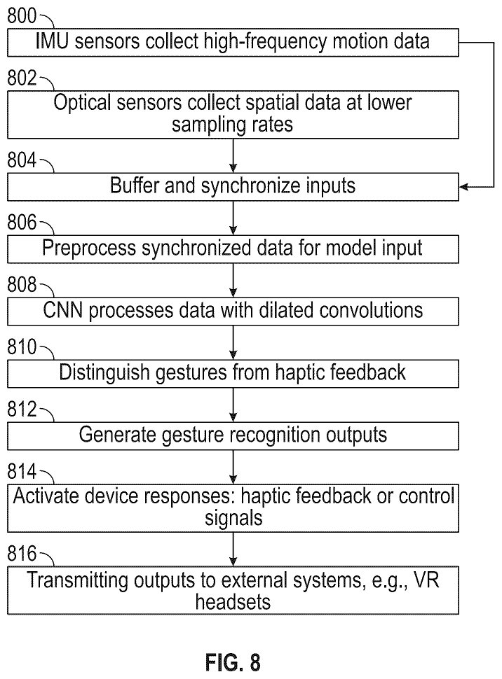

FIG. 8 illustrates a comprehensive data flow architecture of the gesture recognition system, which employs a dual-input processing pipeline for enhanced gesture detection accuracy. The system initiates data collection through two parallel pathways: inertial measurement unit (IMU) sensors collect high-frequency motion data 800 capturing precise temporal movements, while simultaneously, optical sensors gather spatial positioning data 802 at comparatively lower sampling frequencies, providing complementary spatial context for gesture interpretation.

These distinct data streams converge at a buffering and synchronization stage 804, where algorithms harmonize the disparate sampling rates of the IMU and optical sensor inputs. The synchronization process employs temporal alignment techniques to ensure coherent data integration, creating a unified data stream that preserves both the high-frequency motion details and spatial positioning information. The synchronized data subsequently undergoes a preprocessing stage 806, where it is conditioned and formatted according to specific requirements of the model architecture, including normalization and feature extraction processes optimized for gesture recognition.

The preprocessed data streams then enter the convolutional neural network (CNN) processing stage 808, where dilated convolutions analyze the temporal and spatial characteristics of the input signals. This stage implements neural network architectures specifically designed to identify complex gesture patterns while maintaining computational efficiency. The processed data progresses to a discrimination stage 810, which employs sophisticated algorithmic approaches to differentiate between intentional gesture signals and incidental haptic feedback responses, ensuring accurate gesture classification.

Following successful gesture identification, the system generates gesture recognition outputs 812, which are then translated into appropriate device responses 814. These responses manifest either as haptic feedback signals for user interaction or as control signals for system operation, depending on the recognized gesture and system configuration. The process culminates in the transmission stage 816, where the system communicates the processed outputs to external systems, such as virtual reality (VR) headsets, through established communication protocols designed to minimize latency while maintaining signal integrity.

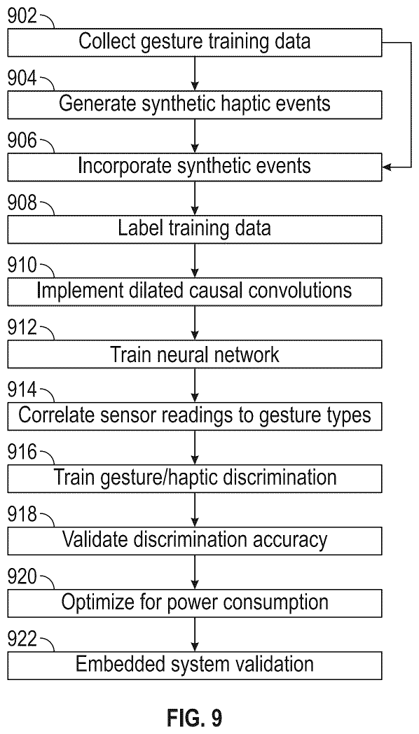

FIG. 9 illustrates a comprehensive neural network training pipeline specifically designed for gesture recognition applications, encompassing multiple processing stages that ensure robust model performance. The process initiates with the collection of gesture training data 902, wherein raw sensor data is systematically acquired from user interactions under controlled conditions, capturing the full range of intended gesture patterns and variations in user execution styles.

Following initial data collection, the system employs signal processing techniques to generate synthetic haptic events 904, creating artificially synthesized data that augments the training dataset with carefully crafted haptic feedback patterns. These synthetic events are methodically incorporated into the training data 906 through a sophisticated fusion process that ensures seamless integration of real-world gesture data with the artificially generated haptic feedback patterns, thereby creating a comprehensive and balanced dataset. The combined dataset then undergoes a labeling process 908, where each data point receives precise taxonomic classification identifying specific gesture types or haptic feedback patterns according to a predetermined classification schema.

The system architecture implements dilated causal convolutions 910, establishing a neural network framework optimized for processing temporal data sequences while maintaining causality in the signal processing chain. This architectural foundation supports the subsequent neural network training phase 912, where the model employs iterative learning algorithms to recognize and classify complex patterns within the input data streams.

The training methodology proceeds through several refined stages, beginning with the correlation of sensor readings to specific gesture types 914, establishing mappings between input signals and recognized gestures. The system then advances to training the discrimination capabilities 916, where the model develops pattern recognition abilities to differentiate between intentional gestures and haptic feedback signals. Validation of discrimination accuracy 918 follows, employing rigorous testing protocols to ensure consistent and reliable performance across various operating conditions.

The pipeline incorporates a dedicated power optimization stage 920, where algorithms fine-tune the model parameters to achieve optimal power efficiency while maintaining high recognition accuracy. The training process culminates in a comprehensive embedded system validation 922, where the trained model undergoes thorough testing within the constraints and specifications of the target embedded hardware platform, ensuring reliable real- world performance.

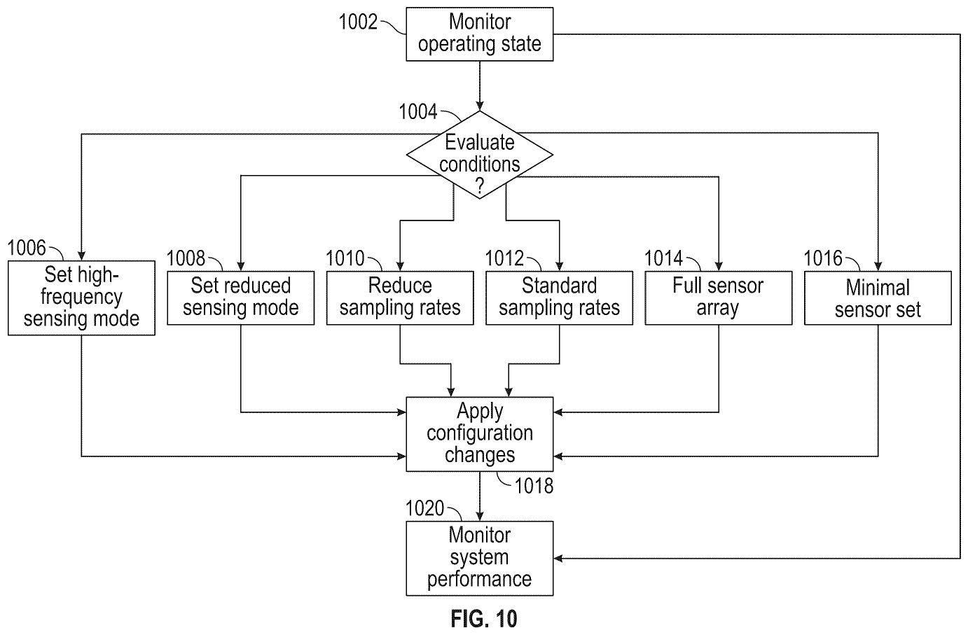

FIG. 10 illustrates a state machine flow designed to implement dynamic system configuration and continuous performance monitoring. The architecture initiates with a monitor operating state 1002, which employs advanced telemetry systems to continuously track and analyze critical system parameters, including power consumption, sensor performance metrics, and overall system efficiency. This monitoring phase feeds directly into an evaluate conditions stage 1004, where complex decision algorithms assess multiple operational parameters against predetermined thresholds and performance criteria.

Based on this comprehensive evaluation, the system can dynamically transition into several specialized operational modes, each optimized for specific operating conditions and performance requirements. The high-frequency sensing mode 1006, positioned on the leftmost path, represents the most intensive data collection configuration, employing maximum sampling rates across active sensor arrays to capture detailed motion and spatial data. The reduced sensing mode 1008 implements a more power-efficient operational profile, while the intermediate configurations of reduce sampling rates 1010 and standard sampling rates 1012 provide calibrated balance points between data fidelity and power consumption.

The architecture further incorporates two distinct sensor array configurations: the full sensor array 1014 activates and utilizes all available sensing elements to maximize data collection capability, while the minimal sensor set 1016 represents the most power-conservative configuration, activating only essential sensors required for maintaining basic system functionality. These varied operational modes converge at the apply configuration changes stage 1018, where control algorithms implement the selected settings across all system components.

Following configuration implementation, the system transitions to a dedicated monitor system performance stage 1020, which employs performance metrics to evaluate the effectiveness of the current configuration. This monitoring stage feeds back to the initial operating state monitoring, creating a closed-loop control system that continuously optimizes system performance based on real-time operational conditions and requirements.

Where appropriate, the functions described herein can be performed in one or more of hardware, software, firmware, digital components, or analog components. For example, the encoding and or decoding systems can be embodied as one or more application-specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In I this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A device, comprising:
a sensor mechanically coupled to a device to detect a gesture;
a haptic feedback component configured to generate haptic feedback in response to detection of the gesture; and
a gesture recognition system comprising a processor configured to:
receive sensor data comprising motion information from the sensor;
process the sensor data using a trained statistical model that has been trained using data comprising both gesture motion data and haptic feedback motion data;
identify a gesture using the trained statistical model by differentiating between first motion information corresponding to a user gesture and second motion information corresponding to haptic feedback generated by the haptic feedback component; and
activate at least one response on the device based on the identified gesture.

2. The device of claim 1, wherein the trained statistical model comprises a convolutional neural network optimized for computational efficiency.

3. The device of claim 2, wherein the sensor comprises: at least one inertial measurement unit (IMU); and/or at least one optical sensor, wherein the convolutional neural network processes input data from either the at least one IMU or the at least one optical sensor, or combined input data from both the at least one IMU and the at least one optical sensor.

4. The device of claim 2, wherein the convolutional neural network employs an architecture configured to: store intermediate outputs from neural network layers in memory; and
reuse the stored intermediate outputs in subsequent processing operations to enhance computational efficiency.

5. The device of claim 1, wherein the gesture recognition system is further configured to: identify a second distinct gesture from the sensor data by: processing overlapping portions of the motion information using the trained statistical model to differentiate between: the first motion information corresponding to the user gesture, the second motion information corresponding to the haptic feedback, and third motion information corresponding to a second user gesture, wherein the first motion information and third motion information may temporally coincide with the second motion information; and activate a second response on the device based on the identified second distinct gesture.

6. The device of claim 1, wherein processing the sensor data comprises determining a moving window of the sensor data to maintain temporal relationships in the motion information.

7. The device of claim 1, wherein the trained statistical model is trained using synthetic haptic feedback events added to gesture training data to enable differentiation between user gestures and haptic feedback during operation.

8. The device of claim 1, further comprising a state machine configured to adjust sensor sampling rates and processing parameters based on a current operating state of the device, wherein an operating state is determined by at least one of: a current application running on the device, a power level of the device, or a type of user interaction being detected.

9. The device of claim 1, wherein the sensor comprises a plurality of channels sampled at different rates, and wherein the processor is configured to buffer data from the plurality of channels to synchronize the sensor data before processing by the trained statistical model.

10. A method for gesture recognition, comprising:
receiving sensor data comprising motion information from a sensor mechanically coupled to a device;
processing the sensor data using a trained statistical model that has been trained using data comprising both gesture motion data and haptic feedback motion data;
identifying a gesture using the trained statistical model by differentiating between first motion information corresponding to a user gesture and second motion information corresponding to haptic feedback generated by a haptic feedback component;
differentiating the second motion information from gesture identification; and
activating at least one response on the device based on the gesture identified and differentiated from the second motion information.

11. The method of claim 10, wherein the trained statistical model comprises a convolutional neural network optimized for computational efficiency in embedded systems, wherein receiving the sensor data comprises:
receiving first sensor data from at least one inertial measurement unit (IMU); and
receiving second sensor data from at least one optical sensor, wherein processing the sensor data comprises processing combined input data from both the IMU and the optical sensor using the convolutional neural network, where processing the sensor data comprises:
storing intermediate outputs from neural network layers in memory; and
reusing the stored intermediate outputs in subsequent processing operations to enhance computational efficiency.

12. The method of claim 10, wherein receiving the sensor data comprises operating the sensor at a first sampling rate for a first type of sensor data and at a second sampling rate for a second type of sensor data, and operating on a moving window of the sensor data to maintain temporal relationships in the motion information.

13. The method of claim 10, wherein the trained statistical model has been trained using synthetic haptic feedback events added to gesture training data to enable differentiation between user gestures and haptic feedback during operation.

14. The method of claim 10, further comprising adjusting sensor sampling rates and processing parameters based on a current operating state of the device, wherein the operating state is determined by at least one of: a current application running on the device, a power level of the device, or a type of user interaction being detected.

15. The method of claim 10, wherein receiving the sensor data comprises: sampling a plurality of channels at different rates; and buffering data from the plurality of channels to synchronize the sensor data before processing by the trained statistical model.

16. The method of claim 10, wherein the trained statistical model comprises a neural network implementing dilated causal convolutions for processing time-series sensor data.

17. The method of claim 16, wherein training the neural network comprises:
generating synthetic haptic feedback events;
incorporating the synthetic haptic feedback events into gesture training data;
training the neural network to discriminate between gesture data and haptic feedback data; performing supervised learning using labeled training data that correlates sensor readings to specific gesture types; and
optimizing the neural network for reduced power consumption in embedded system operation.

18. A method for training a neural network for gesture recognition, comprising:
collecting first sensor data of user gestures from a device having a sensor mechanically coupled to the device;
collecting second sensor data of haptic feedback events generated by a haptic feedback component of the device;
generating a training dataset by combining the first sensor data and the second sensor data, and labeling combined sensor data to identify portions corresponding to user gestures and portions corresponding to haptic feedback events; and
training a statistical model using the training dataset to differentiate between motion information corresponding to user gestures and motion information corresponding to haptic feedback, and identify gestures while excluding the motion information corresponding to haptic feedback.

19. The method of claim 18, wherein training the statistical model comprises:
implementing dilated causal convolutions for processing time-series sensor data;
storing intermediate outputs from each layer to minimize repetitive computations;
optimizing the statistical model by reducing statistical model complexity to meet embedded system memory constraints; and
configuring the statistical model to operate on a moving window of sensor data.

20. The method of claim 19, further comprising:
generating synthetic haptic feedback events; and
incorporating the synthetic haptic feedback events into the training dataset at random intervals.
